(19) United States
(12) Patent Application Publication
(10) Pub. No.: US 2021/0301947 A1
(43) Pub. Date: Sep. 30, 2021

(54) MOLDED AIRCRAFT WIRING AND/OR TUBING SUPPORT BRACKETS

(71) Applicant: EMBRAER S.A., Sao Jose dos Campos-SP (BR)

(72) Inventor: Denizete Borges da CUNHA, São José dos Campos-SP (BR)

(21) Appl. No.: 17/214,535

(22) Filed: Mar. 26, 2021

Related U.S. Application Data
(60) Provisional application No. 63/001,789, filed on Mar. 30, 2020.

(51) Int. Cl. F16L 3/127

(52) U.S. Cl. CPC F16L 3/127; B64D 2221/00

(57) ABSTRACT

One-piece molded thermoplastic L-shaped and Z-shaped support brackets are described for supporting wiring and/or tubing. The support brackets will include a lower support flange, a backing flange, and a junction region having a concave inner surface and a convex outer surface which integrally joins the lower support flange and the backing flange to one another at a substantially right angle. The support bracket may further comprises right and left generally triangularly-shaped side walls integrally joining the lower support flange and the backing flange. The Z-shaped support bracket will additionally include an upper support bracket integrally joined to an upper end of the backing flange and extending rearwardly therefrom substantially parallel to the lower support bracket. A second junction region having a concave inner surface and a convex outer surface will thus integrally join the upper support flange and backing flange to one another at a substantially right angle.

### CROSS-REFERENCE TO RELATED APPLICATION

This application is based on and claims domestic priority benefits of U.S. Provisional Application Ser. No. 63/001,789 filed on Mar. 30, 2020, the entire contents of which are expressly incorporated herein by reference.

### FIELD

The embodiments disclosed herein relate generally to wiring and/or tubing support brackets that may be employed usefully to route wiring and/or tubing within an aircraft. In preferred forms, the support brackets are embodied in one-piece molded thermoplastic bracket structures to which a wiring mount and/or tubing clamp may be operatively connected.

### BACKGROUND

L-shaped and Z-shaped metal brackets are conventionally employed in the aviation industry to support and route electrical wiring, cable harnesses and tubing (e.g., pneumatic, hydraulic and fuel lines) within aircraft components such as the aircraft's fuselage and aerodynamic structures. The principal difference between the metallic supports is typically embodied in the surface finishing and/or the specific hardware installation (e.g., a backing nut plate or a wire/cable support) that is attached to the bracket.

Conventional metal brackets may be coated with primer and/or polyurethane finishes which promote corrosion protection. However, there is the possibility that a bracket that is not coated or incorrectly coated may be installed onto the aircraft's structure which in turn affects the maintenance cycle time for such components. Conventional metal support brackets therefore typically require special surface treatment and/or coating in controlled paint booths which in turn increases part costs due to the involved manpower as well as environmental licensing requirements. Due to such surface treatments and/or paint coatings, it is also typically more difficult to recycle conventional metal support brackets.

It would therefore be highly desirable if non-metal aircraft wiring and/or tubing support brackets could be provided which minimize if not eliminate the problems noted above which are attendant to conventional metal support brackets. It is towards fulfilling such needs that the embodiments disclosed herein are directed.

### BRIEF DESCRIPTION

Broadly, the embodiments disclosed herein are directed toward one-piece molded thermoplastic L-shaped support bracket for supporting wiring and/or tubing, the support bracket comprising a lower support flange, a backing flange; and a junction region having a concave inner surface and a convex outer surface which integrally joins the lower support flange and the backing flange to one another at a substantially right angle. The support bracket may further comprises right and left generally triangularly-shaped side walls integrally joining the lower support flange and the backing flange.

Each of the right and left side walls may a perimeter flange having a generally triangularly-shaped lateral edge, and a side wall plate joined to the lateral edge of the perimeter flange. The side walls will generally define a right triangle with respective adjoining right angle legs being integral with the lower support flange and the backing flange and a planar or concavely curved hypotenuse leg extending downwardly from the backing flange to a terminal end of the lower support flange.

According to some embodiments, a Z-shaped support bracket is provided which is structurally similar to the L-shaped support bracket but includes an upper support bracket integrally joined to an upper end of the backing flange and extending rearwardly therefrom substantially parallel to the lower support bracket. A second junction region having a concave inner surface and a convex outer surface may therefore be provided so as to integrally join the upper support flange and backing flange to one another at a substantially right angle.

The backing flange of the L-shaped support bracket or the upper support flange of the Z-shaped support bracket may be provided with a pair of lateral convex lobes and a central concave recess between the convex lobes. The lower support flange may define a bolt-receiving aperture for allowing a nut back plate or a wiring mount to be operatively associated therewith. The backing support flange of the L-shaped support bracket or the upper support flange of the Z-shaped support bracket may also be provided with a pair of apertures to facilitate connection of the bracket to adjacent structural components of the aircraft.

These and other aspects and advantages of the present invention will become more clear after careful consideration is given to the following detailed description of the preferred exemplary embodiments thereof.

### BRIEF DESCRIPTION OF ACCOMPANYING DRAWINGS

The disclosed embodiments of the present invention will be better and more completely understood by referring to the following detailed description of exemplary non-limiting illustrative embodiments in conjunction with the drawings of which:

FIG. 1 is an enlarged perspective view of a portion of an aircraft interior showing representative L-shaped and Z-shaped molded support brackets in accordance with embodiments of the invention;

FIGS. 2 and 3 are top front perspective views of an L-shaped molded support bracket in accordance with one embodiment of the invention, wherein FIG. 2 depicts a backing nut plate attached to the top surface of the support flange thereof while FIG. 3 depicts the backing nut plate separated from such support flange;

FIGS. 4 and 5 are bottom rear perspective views of the L-shaped molded support bracket shown in FIGS. 2 and 3 but provided with a wiring mount attached to the bottom surface of the support flange, wherein FIG. 4 depicts the wiring mount attached to the bottom surface of the support flange while FIG. 5 depicts the wiring mount separated from such support flange;

FIG. 6 is a right front perspective view of the L-shaped molded support bracket in accordance with an embodiment of the invention;

FIGS. 7 and 8 are front and rear elevational views, respectively, of the L-shaped molded support bracket shown in FIG. 6;

FIGS. 9 and 10 are top and bottom plan views, respectively, of the L-shaped molded support bracket shown in FIG. 6;

FIGS. 11 and 12 are left and right elevational views, respectively, of the L-shaped molded support bracket shown in FIG. 6;

FIGS. 13 and 14 are rear and front perspective views, respectively, of a Z-shaped molded support bracket in accordance with one embodiment of the invention, wherein FIG. 13 depicts a wiring mount attached to the bottom surface of the support flange thereof while FIG. 13 depicts the wiring mount separated from such support flange;

FIGS. 15 and 16 are each front perspective views of the Z-shaped molded support bracket shown in FIGS. 13 and 14 but provided with a backing nut plate attached to the top surface of the support flange, wherein FIG. 15 depicts the backing nut plate attached to the top surface of the support flange while FIG. 16 depicts the backing nut plate separated from such support flange;

FIG. 17 is a left front perspective view of the Z-shaped molded support bracket in accordance with an embodiment of the invention;

FIGS. 18 and 19 are front and rear elevational views, respectively, of the Z-shaped molded support bracket shown in FIG. 17;

FIGS. 20 and 21 are bottom and top plan views, respectively, of the Z-shaped molded support bracket shown in FIG. 17; and

FIGS. 22 and 23 are right and left elevational views, respectively, of the Z-shaped molded support bracket shown in FIG. 17.

### DETAILED DESCRIPTION OF EMBODIMENTS

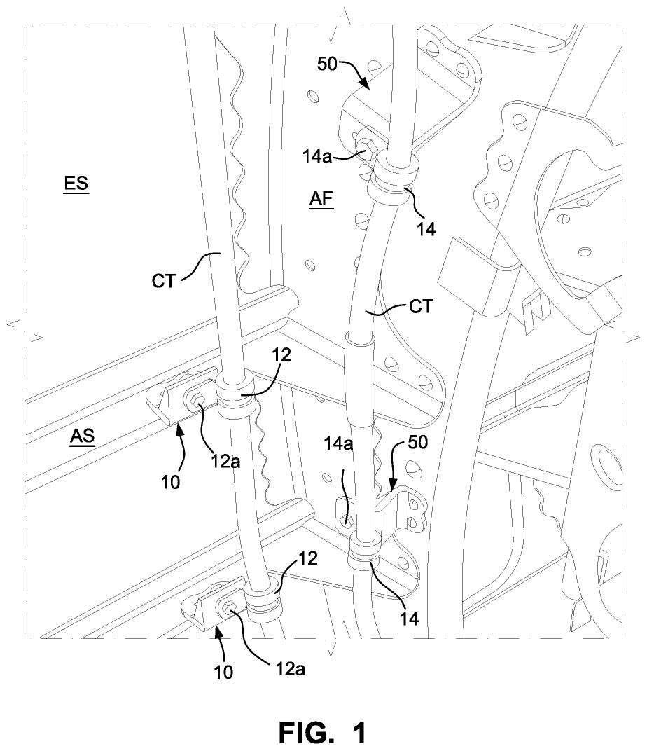

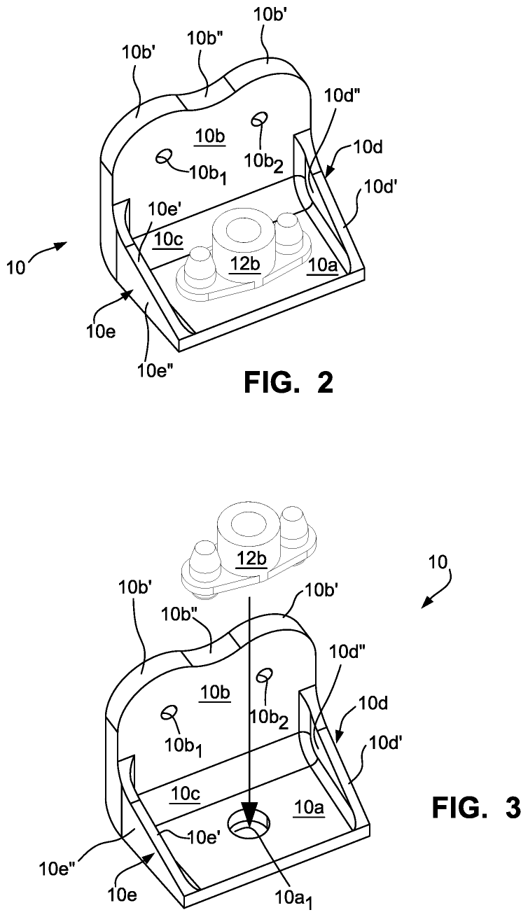

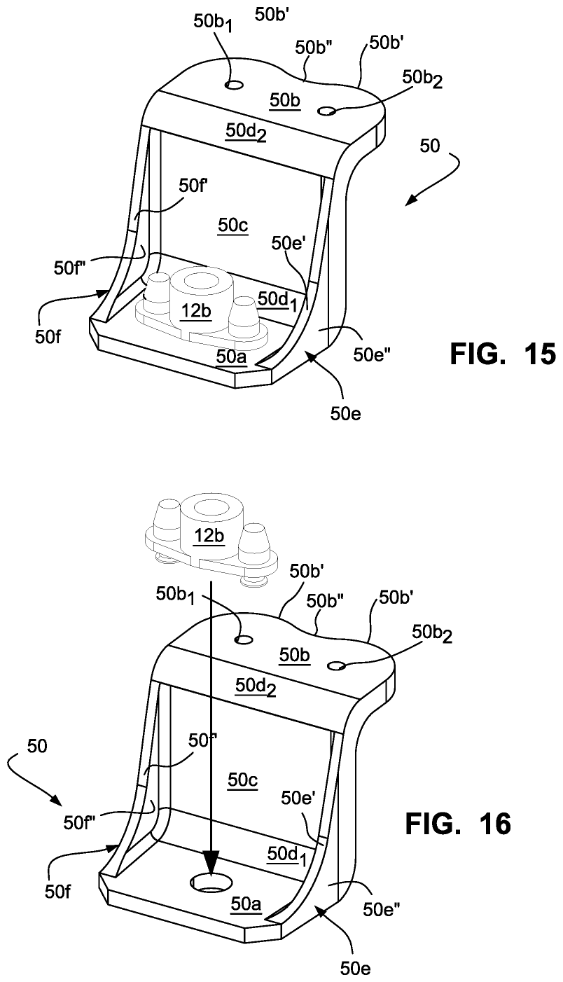

An exemplary interior portion of an aircraft structure (e.g., the aircraft's fuselage, wing or other interior structural component) is depicted in FIG. 1. More specifically, accompanying FIG. 1 depicts an interior of an aircraft comprised of conventional aircraft structural components such as an airframe component AF, an aircraft stringer component AS and external skin component ES which are connected together so as to collectively form a portion of the aircraft structure. As shown, several of the L-shaped molded support brackets 10 and Z-shaped molded support brackets 50 in accordance with the embodiments disclosed herein are connected to the aircraft stringer component AS and airframe component AF, respectively, so as to support cable and/or tubing CT being routed from between locations of the aircraft. The cable and/or tubing CT is physically attached to and thereby supported by the brackets 10 and 50 via conventional clamps 12 and 14, respectively (e.g., by means of bolts 12a, 14a being threadably connected to a nut back plate 12b, 14b, respectively, which are not shown in FIG. 1, but depicted in FIGS. 2-3 and 15-16). It will be understood in this regard that the brackets 10, 50 could alternatively be provided with wiring mounts 16 (see FIGS. 4-5 and 13-14) so as to allow wiring harnesses, electrical and/or electronic cables to be physically tied to and thus supported by the brackets 10, 50.

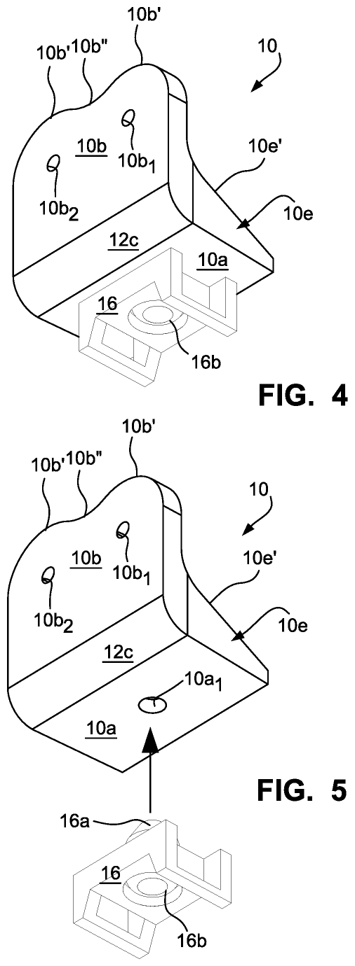

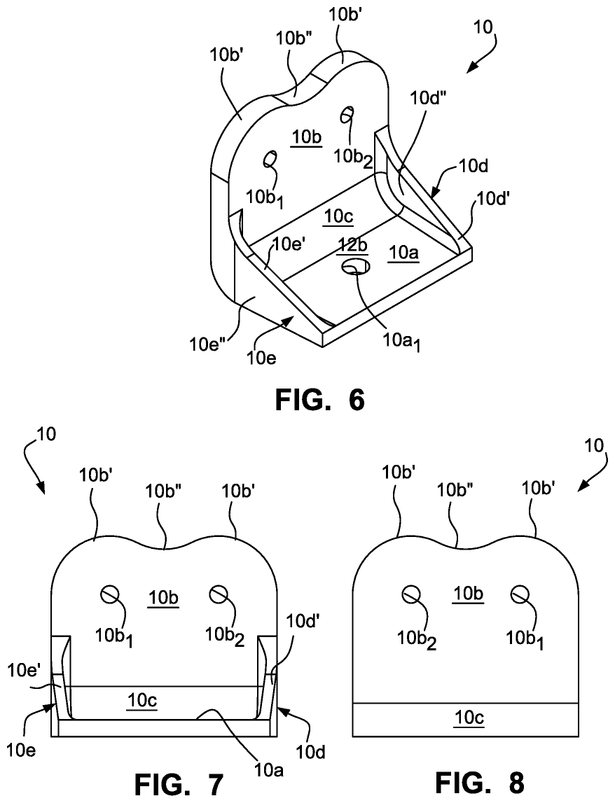

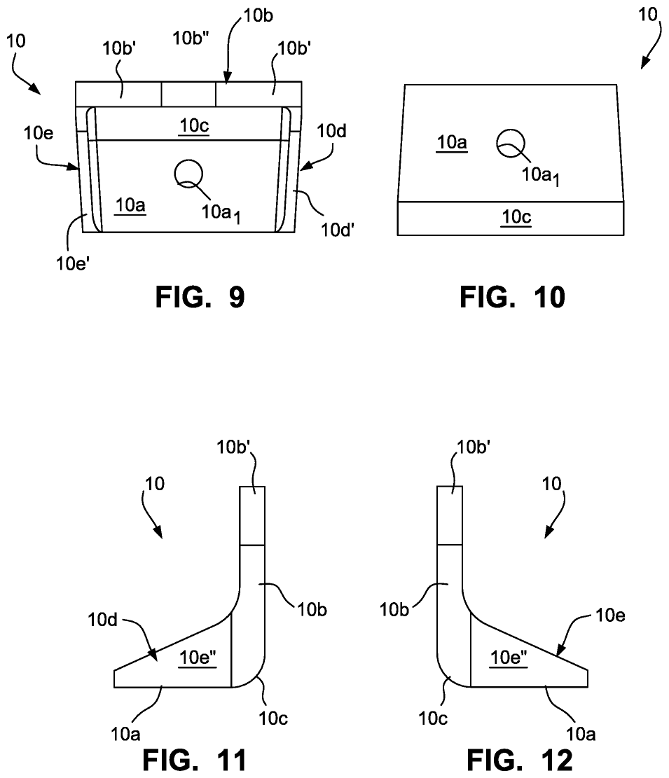

The L-shaped molded support bracket 10 in accordance with an embodiment of this invention is shown in greater detail in accompanying FIGS. 2-12. As shown therein, the bracket 10 is essentially a one-piece component structure molded from a suitable thermoplastics material (e.g., nylon, polyolefin or the like). Most preferably the bracket 10 is an injection-molded one-piece component formed of a suitable injection moldable thermoplastic material. The embodiment of the support bracket 10 depicted in the accompanying FIGS. 2-12 includes a lower support flange 10a and a backing flange 10b at substantially a right angle (90°) relative to one another. The junction region 10c integrally joining the lower and backing flanges 10a, 10b, respectively, is most preferably a curved transition having a concave inner surface and a convex outer surface. As is perhaps shown more clearly by FIG. 7, the lower support flange 10a is outwardly convergingly tapered such that the distalmost free end has a lesser dimension as compared to the dimension of the proximal end joined to the junction region 10c.

The lower and backing flanges 10a, 10b are integrally joined to one another by opposed generally triangularly-shaped right and left side walls 10d, 10e, respectively. Each of the side walls 10d, 10e includes a generally triangular perimeter flange 10d′, 10e′ and a side wall plate 10d″, 10e″ joined to the lateral edges thereof, respectively. The side walls 10d, 10e thereby generally define a right triangle with respective adjoining right angle legs being integral with the lower and backing support flanges 10a, 10b and a substantially planar hypotenuse leg extending downwardly from the backing support flange 10b to the terminal end of the lower support flange 10a.

The backing flange 10b includes a pair of lateral convex lobes 10b′ and a central concave recess 10b″. An aperture 10a-1 may be formed in the lower support flange 10a so as to accommodate the bolt 12a when using the nut back plate 12b or to allow a bolt 16b to be threadable engaged with a backing nut 16a (see FIGS. 4 and 5) and thereby attach the wiring mount 16 to the lower support flange 10a. Apertures 10b₁ and 10b₂ may also be formed in the backing flange 10b so as to allow the bracket 10 to be attached physically to aircraft structures (e.g., via rivets, screws, bolts and the like).

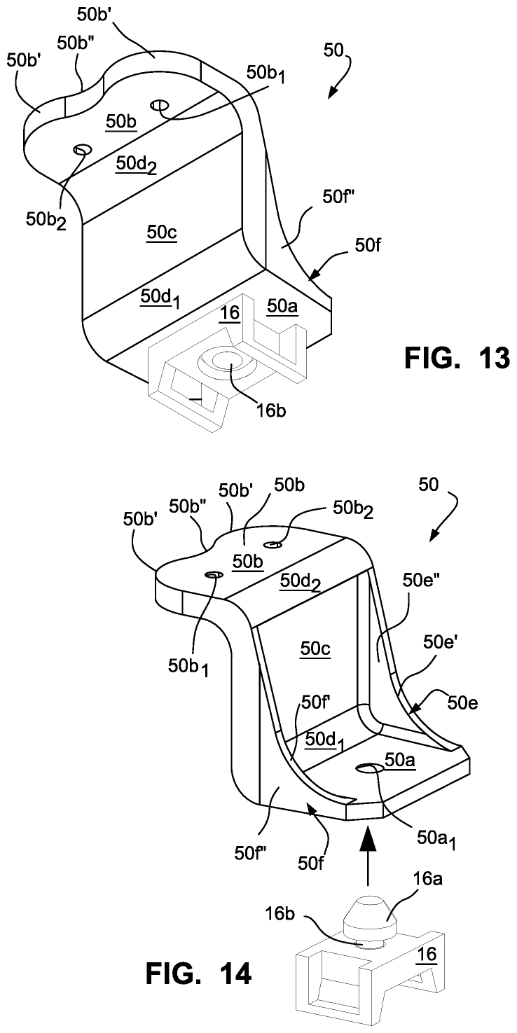

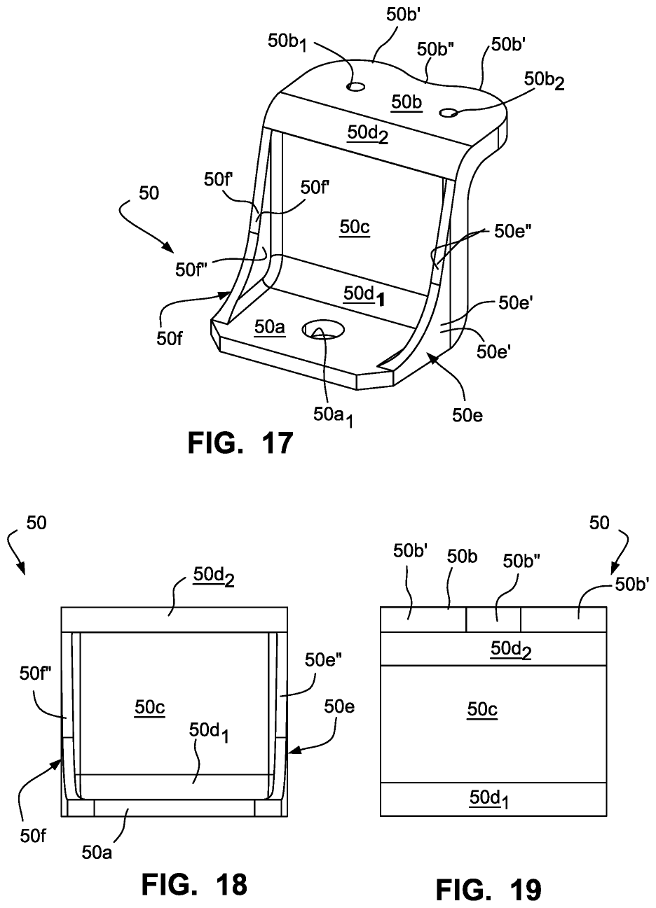

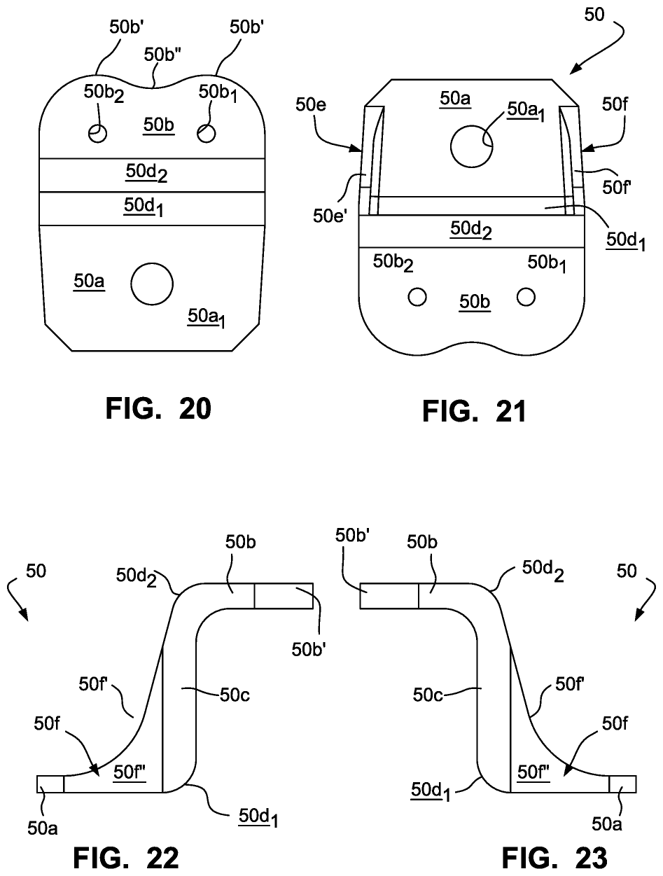

The Z-shaped molded support bracket 50 in accordance with an embodiment of this invention is shown in greater detail in accompanying FIGS. 13-23. As shown therein, the bracket 50 is essentially a one-piece component structure molded from a suitable thermoplastics material (e.g., nylon, polyolefin or the like). Most preferably the bracket 50 is an injection-molded one-piece component formed of a suitable injection moldable thermoplastic material. The embodiment of the support bracket 50 depicted in the accompanying FIGS. 13-23 includes a lower forwardly extending support flange 50a, an upper rearwardly extending support flange 50b and a central backing flange 50c having lower and upper ends respectively joined to the lower and upper support flanges 50a, 50b. As shown, the lower and upper support flanges 50a, 50b, respectively, are essentially parallel to one another with the central backing flange 50c being joined to the lower and upper support flanges 50a, 50b at substantially right angles (90°) relative thereto. The forward edge of the lower backing flange 50a may have beveled corners.

Junction regions 50d₁, 50d₂ respectively integrally join the lower and upper support flanges 50a, 50b to the central support flange 50c. Each of the junction regions 50d₁, 50d₂ is most preferably a curved transition having a concave inner surface and a convex outer surface.

The lower and backing flanges 50a, 50c, respectively, are integrally joined to one another by opposed generally triangularly-shaped right and left side walls 50e, 50f, respectively. Each of the side walls 50e, 50f includes a generally triangular perimeter flange 50e′, 50f′ and a side wall plate 50e″, 50f″ joined to the lateral edges thereof, respectively. The side walls 50e, 50f thereby generally define a right triangle with respective adjoining right angle legs being integral with the lower and backing support flanges 50a, 50c and a concavely curved hypotenuse leg extending downwardly from the backing support flange 50c to the terminal end of the lower support flange 50a.

The upper support flange 50b includes a pair of lateral convex lobes 50b′ and a central concave recess 50b″. An aperture 50a-1 may be formed in the lower support flange 50a so as to accommodate the bolt 12a when using the nut back plate 12b or to allow a bolt 16b to be threadable engaged with a backing nut 16a (see FIGS. 13 and 14) and thereby attach the wiring mount 16 to the lower support flange 50a. Apertures 50b₁ and 50b₂ may also be formed in the backing flange 50b so as to allow the bracket 50 to be attached physically to aircraft structures (e.g., via rivets, screws, bolts and the like).

While reference is made to particular embodiments of the invention, various modifications within the skill of those in the art may be envisioned. Therefore, it is to be understood that the invention is not to be limited to the disclosed embodiment, but on the contrary, is intended to cover various modifications and equivalent arrangements included within the spirit and scope thereof.

What is claimed is:

1. A one-piece molded thermoplastic support bracket for supporting wiring and/or tubing, the support bracket comprising:
a lower support flange,
a backing flange; and
a junction region having a concave inner surface and a convex outer surface which integrally joins the lower support flange and the backing flange to one another at a substantially right angle.

2. The support bracket according to claim 1, which further comprises right and left side walls integrally joining the lower support flange and the backing flange.

3. The support bracket according to claim 2, wherein the right and left side walls are generally triangularly-shaped.

4. The support bracket according to claim 3, wherein each of the right and left side walls includes a perimeter flange having a generally triangularly-shaped lateral edge, and a side wall plate joined to the lateral edge of the perimeter flange.

5. The support bracket according to claim 3, wherein the side walls generally define a right triangle with respective adjoining right angle legs being integral with the lower support flange and the backing flange and a hypotenuse leg extending downwardly from the backing flange to a terminal end of the lower support flange.

6. The support bracket according to claim 1, wherein the backing flange includes a pair of lateral convex lobes and a central concave recess between the convex lobes.

7. The support bracket according to claim 1, wherein the lower support flange defines a bolt-receiving aperture.

8. The support bracket according to claim 7, comprising a nut back plate or a wiring mount operatively associated with the bolt-receiving aperture.

9. The support bracket according to claim 1, wherein the backing flange comprises a pair of apertures.

10. An aircraft which comprises the support bracket according to claim 1.

11. The support bracket according to claim 1, further comprising an upper support bracket integrally joined to an upper end of the backing flange and extending rearwardly therefrom substantially parallel to the lower support bracket.

12. The support bracket according to claim 11, which further comprises a second junction region having a concave inner surface and a convex outer surface which integrally joins the upper support flange and backing flange to one another at a substantially right angle.

13. The support bracket according to claim 11, which further comprises right and left side walls integrally joining the lower support flange and the backing flange.

14. The support bracket according to claim 13, wherein the right and left side walls are generally triangularly-shaped.

15. The support bracket according to claim 14, wherein each of the right and left side walls includes a perimeter flange having a generally triangularly-shaped lateral edge, and a side wall plate joined to the lateral edge of the perimeter flange.

16. The support bracket according to claim 15, wherein the side walls generally define a right triangle with respective adjoining right angle legs being integral with the lower support flange and the backing flange and a concavely curved hypotenuse leg extending downwardly from the backing flange to a terminal end of the lower support flange.

17. The support bracket according to claim 11, wherein the upper support flange includes a pair of lateral convex lobes and a central concave recess between the convex lobes.

18. The support bracket according to claim 11, wherein the lower support flange defines a bolt-receiving aperture.

19. The support bracket according to claim 18, comprising a nut back plate or a wiring mount operatively associated with the bolt-receiving aperture.

20. The support bracket according to claim 11, wherein the upper support flange comprises a pair of apertures.

21. An aircraft which comprises the support bracket according to claim 11.
